(19) United States
(12) Patent Application Publication
(10) Pub. No.: US 2009/0021623 A1
(43) Pub. Date: Jan. 22, 2009

(54) Systems, methods and devices for a CMOS imager having a pixel output clamp

(75) Inventors: Taehee Cho, Irvine, CA (US); Hai Yan, Fontana, CA (US); Christopher Zeleznik, Los Angeles, CA (US); Chiajen Lee, Irvine, CA (US)

Correspondence Address: DORSEY & WHITNEY LLP;INTELLECTUAL PROPERTY DEPARTMENT, SUITE 3400, 1420 FIFTH AVENUE, SEATTLE, WA, 98101, US

(73) Assignee: Micron Technology, Inc., Boise, ID (US)

(21) Appl. No.: 11/880,072

(22) Filed: Jul. 18, 2007

(51) Int. Cl. H04N 5/335

(52) U.S. Cl. 348/308; 348/E05.091

(57) ABSTRACT

Embodiments of a pixel read out circuit in an imager device is described. The pixel read out circuit includes an output node that is connected to a plurality of pixel cells. An output signal from a selected one of the plurality of pixel cells is applied to the output node. The pixel read out circuit also includes a clamp-out circuit that limits the magnitude of the output signal to a voltage determined by the voltage of a reference signal to prevent the output signal from reaching a level that might exceed the dynamic range of analog circuitry receiving the output signal.

### TECHNICAL FIELD

Embodiments of the present invention relate generally to imaging devices, and more specifically, to a complementary metal oxide semiconductor (CMOS) imager having a clamp circuit.

### BACKGROUND

Conventional complimentary metal oxide semiconductor (“CMOS”) imagers are integrated circuit devices capable of converting an optical image into an electrical image signal. The CMOS imager usually includes a focal plane array of light-sensing elements, referred to as “pixel cells,” and readout circuitry that outputs signals indicative of the light sensed by the pixels. Each pixel cell includes a photodetector, such as a photogate, photoconductor, a photodiode, or other type of photosensor, for accumulating photo-generated charge in a specified portion of the substrate. The photosensor capacitance of the specified portion is discharged through a constant integration of time at a rate that is approximately proportional to incident light illumination. The charge rate of the photosensor capacitance is used to convert the optical signal to an electrical signal, as is known in the art. A readout circuit for pixel readout is coupled to the photosensor, and includes at least a source follower transistor and a row select transistor for coupling the source follower transistor to a column output line. Charge that is generated by the photosensor is sent to a sensing region, typically a floating diffusion node, connected to the gate of the source follower transistor. The imager may also include a device, such as a transistor, for transferring charge from the photosensor to the floating diffusion node, and another device, also typically a transistor, for resetting the storage region to a predetermined charge level prior to charge transference.

FIG. 1 illustrates a block diagram of a prior art CMOS imager device 100 having a pixel array 110 of light-sensing photosensors as previously described, or as implemented by other circuitry known in the art. A plurality of pixel cells arranged in rows and columns are respectively connected to a plurality of row and column lines that are provided for the entire array 110. The pixels of each row in the array 110 are accessed at the same time by a row select line coupled to respective drivers (not shown) in response to a row address received by a row decoder 122. Similarly, the pixels of each column in the array 110 are selectively outputted by respective column select lines coupled to drivers (also not shown) in response to a column address being decoded by a column decoder 124. Therefore, each pixel has a row address and a column address.

A control block 120 controls the operation of the CMOS imager device 100, which includes controlling the address decoders 122, 124 for selecting the appropriate row and column lines for pixel readout. As known in the art, the pixel output signals typically include a pixel reset signal Vᵣₑₛₑₜ that is read out of the sensing region or the diffusion node after the pixel cell is reset and a pixel image signal V_{signal}, which is read out of the diffusion region after photo-generated charges are transferred to the region due to the impinging light on the photosensor. A sampling circuit 130 samples the Vᵣₑₛₑₜ and the V_{signal} signals and provides the signals to an amplifier, such as a programmable gain amplifier (PGA) 134. The signals are typically subtracted by the amplifier 134 to generate an output signal Vₒᵤₜ. The control block 120 may additionally provide a gain control signal GAIN to the amplifier 134 to amplify the received Vₒᵤₜ signal as needed. Taking the difference between the two signals, Vᵣₑₛₑₜ−V_{signal}, which is also known as correlated double sampling (CDS) in the art, represents the amount of light impinging on the pixel. The Vₒᵤₜ signal is then converted to a digital signal by an analog-to-digital converter (ADC) 132 to produce a digital image signal IMAGE_OUT that may be electronically stored or further processed to form a digital image.

The control block 120 also provides various timing signals to synchronize a number of the components in the device 100. FIG. 2 illustrates the operation of the device 100 using a timing diagram of various timing signals. The timing signals represent signals for operating four pixel cell read outs in four columns of the array 110, which are labeled pix_out1, pix_out2, pix_out3, and pix_out4. As previously described, each operation involves a reset stage and a signal sampling stage. The control block 120 provides a sample and hold reset (SHR) pulse and a sample and hold sample (SHS) pulse to the sampling circuit 130 to respectively enable resetting and sampling signals of the pixel array 110. A reset enable pulse RX_N is generated at time T0 in response to the SHR pulse, which charges the diffusion node to a high voltage such as V_{CC}. As a result, the pix_out signals are initially set high indicated by a level A, and the pixel cells are reset for the sampling stage. At time T1, a transfer enable pulse TX_N is generated responsive to the SHS pulse. Impinging light on the photosensor causes its capacitance to discharge, as previously described, causing the voltage at the diffusion node to decrease as shown by a drop in the pix_out signals at a level B. The Vₒᵤₜ signal is calculated by taking the difference of the signal at level B from the signal at level A.

The control block 120 additionally provides a clock signal CLK to the column decoder 124 and to a clock generator 136 that is used to calculate the output signal and convert the output signal to the IMAGE_OUT signal. At the first rising edge of the CLK signal at time T2, all the pixel cells are reset in response to a reset signal. At about the same time, the first address is received by the column decoder 124 and the signal of the first pixel cell is sampled as shown by the pix_out1 signal. The Vₒᵤₜ signal is calculated and amplified by the amplifier 134 as shown by the first PGA_out signal occurring after some delay after time T2. The first IMAGE_OUT signal is then generated from the PGA_out signal after another delay. Similarly at time T3, a second address is received at the next rising edge of the CLK signal to generate the second PGA_out signal after some delay to generate the pix_out2 signal. The third and fourth PGA_out signals are generated in the same manner in response to addresses received at times T3 and T4, to generate the pix_out3 and pix_out4 signals, respectively.

Prior art imaging devices like the device 100 utilize PGA amplifiers, such as the amplifier 134, to achieve high signal-to-noise ratio (SNR) at low light conditions. However, the problem with conventional devices is that, in some cases, the pixel output may be much greater than the allowable dynamic range of the PGA 134 for the next several clock cycles. While the pix_out 1,3,4 signals exhibit reasonable Vₒᵤₜ signals, as evidenced by the normal respective PGA_out signals, the pix_out2 signal is shown to output a Vₒᵤₜ₂ signal at column 2 of the pixel array 110 having a very low output, shown as level C, that may exceed the dynamic range of the PGA 134. Consequently, the PGA_out signal of column 2 is shown to be overdriven and surpassing the allowable rail-to-rail voltage range of the PGA 134 at time T4. The effects of the overdriven PGA_out signal of column 2 is also shown to impact the PGA_out signal of column 3 at time T5, which subsequently also affects its ADC 132 output. The resulting IMAGE_out signal for column 3 generated by the ADC 132 is much smaller than the expected value. Therefore, excessively large pixel output signals cause an analog signal chain 105 to become overdriven, which may cause errors in the resulting digital image.

There is, therefore, a need to reduce overdriving the analog signal chain of imager devices.

### BRIEF DESCRIPTION OF THE DRAWINGS

FIG. 1 is a block diagram of a prior art CMOS imager device.

FIG. 2 is a timing diagram illustrating various timing signals during the operation of the CMOS imager device of FIG. 1.

FIG. 3 is a block diagram of a CMOS imager device according to an embodiment of the invention.

FIG. 4 is a schematic diagram of a pixel column in a pixel array coupled to a clamping circuit according to another embodiment of the invention.

FIG. 5 is a timing diagram illustrating various timing signals for operating the CMOS imager device of FIG. 3 according to an embodiment of the invention.

FIG. 6 is a simplified block diagram of a processor-based system that includes the CMOS imager device of FIG. 3 according to another embodiment of the invention.

FIG. 7 is a block diagram of a consumer device and a processor having the CMOS imager device of FIG. 3 according to another embodiment of the invention.

### DETAILED DESCRIPTION OF PREFERRED EMBODIMENTS

Certain details are set forth below to provide a sufficient understanding of embodiments of the invention. However, it will be clear to one skilled in the art that embodiments of the invention may be practiced without these particular details. Moreover, the particular embodiments of the present invention described herein are provided by way of example and should not be used to limit the scope of the invention to these particular embodiments. In other instances, well-known circuits, control signals, and timing protocols have not been shown in detail in order to avoid unnecessarily obscuring the invention.

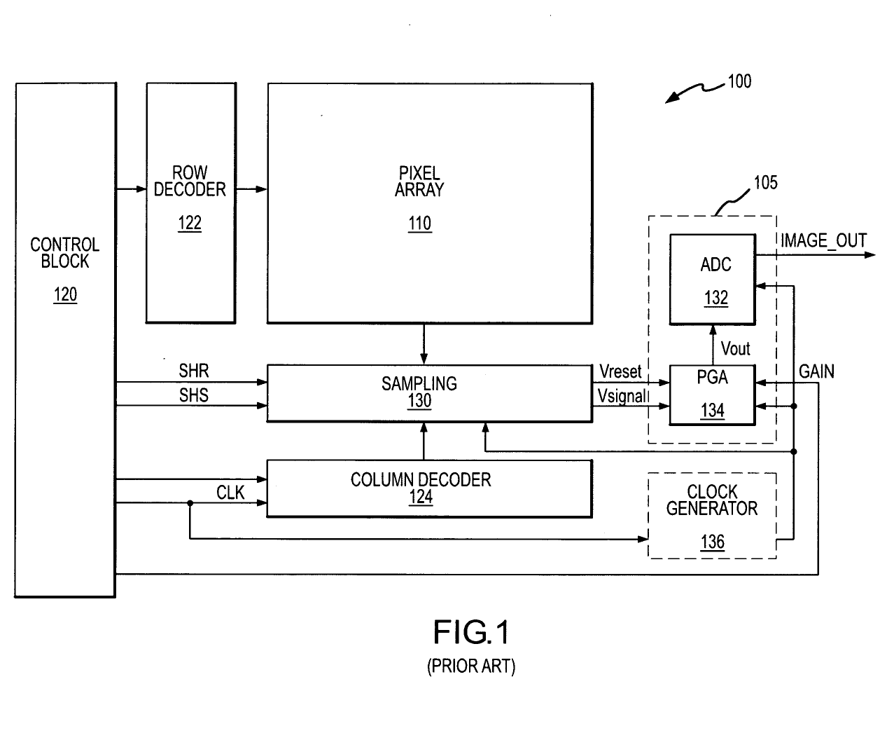

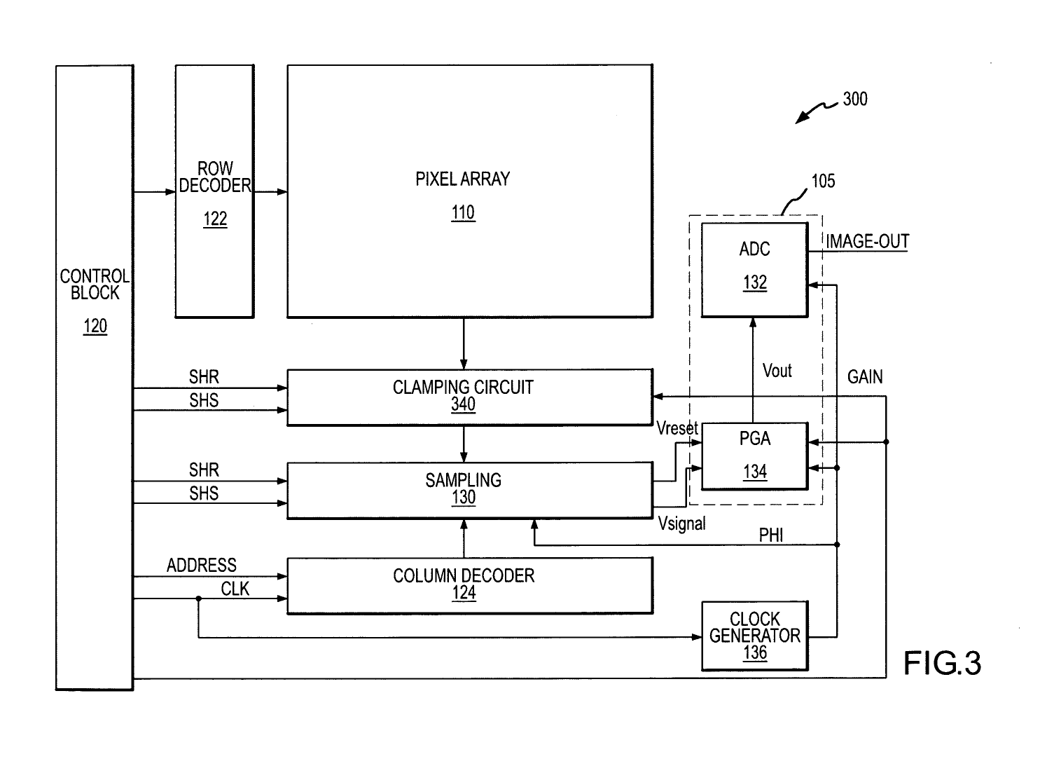

FIG. 3 is a block diagram of a CMOS imager device 300 according to an embodiment of the invention. Much of the components shown in FIG. 3 have been previously described with respect to FIG. 1, and are identified in FIG. 3 by the same reference numerals. Therefore, in the interest of brevity, an explanation of the structure and operation of these same components will not be repeated. The imager device 300 includes a clamping circuit 340 at the output of the pixel array 110. The clamping circuit 340 clamps the pixel output to a predetermined signal level, such as a reference voltage, to prevent the analog signal chain 105 of the imager device 300 from becoming overdriven due to large pixel output signals. The reference voltage may be controlled by the gain of the analog signal chain 105, indicated by the gain enable signal received by the clamping circuit 340, to ensure the final output provided to the sampling circuit 130 is within the rail-to-rail limitations of the analog signal chain 105. Details of the clamping circuit 340 will now be described.

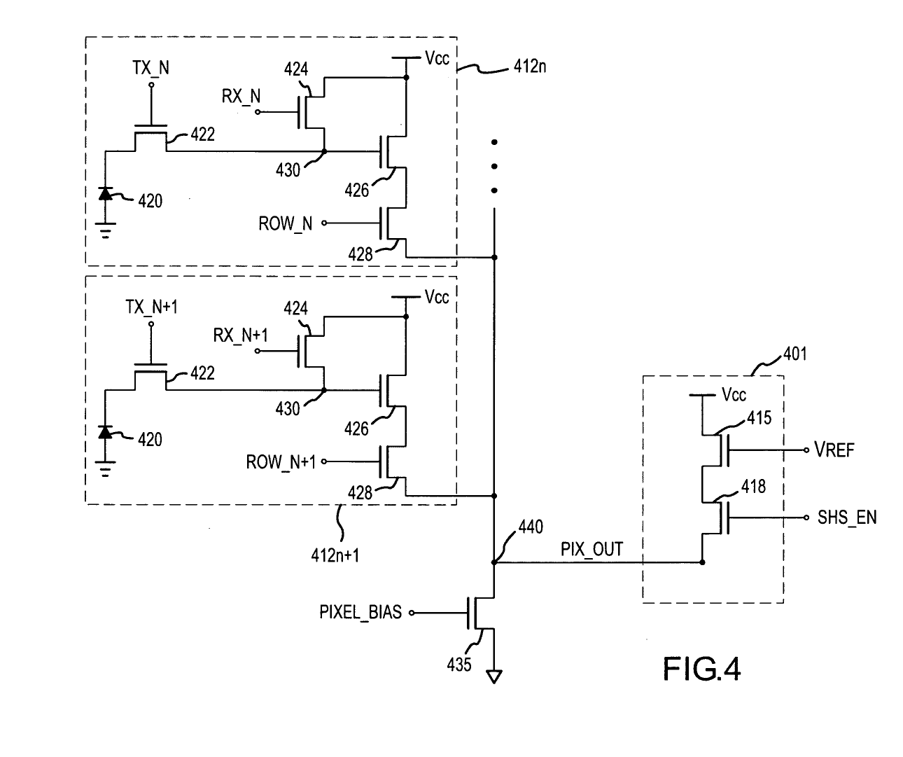

A simplified schematic of a unit clamping circuit 401 coupled to a single column of the pixel array 110 is shown in FIG. 4 according to an embodiment of the invention. It will be understood that a plurality of pixel cells in the pixel array 110 are arranged in a single column and coupled to a respective column line, as previously described. Each pixel cell 412 includes a photodiode 420 as the photosensor, a floating diffusion node 430 and four transistors 422-428. The photodiode 420 is coupled to a transfer transistor 422 that is enabled by the TX_N signal to allow a transfer of charge to the floating diffusion node 430 as light impinging on the photodiode 420 is converted to an electrical charge. A reset transistor 424 is also connected to the floating diffusion node 430 so that during the reset stage, the node 430 may be recharged to a supply voltage V_{CC} when the transistor 424 is enabled by the RX_N signal. The diffusion node 430 is additionally connected to the gate of a source follower transistor 426 such that the charge at the diffusion node 430 controls the conductivity of the transistor 426. The output of the transistor 426 is provided to a load transistor 435 through a row select transistor 428 that is enabled by a row select signal ROW_N. The load transistor 435 is enabled by a bias signal PIXEL_BIAS when the column line is selected. A pixel cell 412n+1 following the pixel cell 412n on the same column line represents one of a plurality of pixel cells coupled to the column line at node 440.

In operation, the pixel row is selected when the ROW_N signal is asserted to cause the row select transistor 428 to conduct. The pixel cell 412n is reset when RX_N is asserted during the reset stage to couple the diffusion node 430 to the voltage source and charge the node 430 to V_{CC}. The pixel cell 412n outputs Vᵣₑₛₑₜ signal as a PIX_OUT signal to be sampled, as described previously. The RX_N signal is then disabled and the TX_N signal is asserted to couple the diffusion node 430 to the photodiode 420 being exposed to the incident light during a charge integration period. Electrical charge is transferred through the transfer transistor 422, which decreases the voltage at the diffusion node 430, as previously described, and the pixel cell 412n outputs a V_{signal} signal as the PIX_OUT signal to be sampled. The difference between the Vᵣₑₛₑₜ and V_{signal} signals yields the overall pixel output. The pixel cell 412n+1 includes the same components and operates in the same manner as pixel cell 412n, except that the pixel cell 412n+1 is enabled by a row select signal ROW_N+1, and in the interest of brevity, the pixel cell 412n+1 is not described further.

Each of the column lines in the pixel array 110 are also coupled to a respective unit clamping circuit 401, thus a plurality of clamping circuit units 401 comprise the clamping circuit 340 of FIG. 3. The unit clamping circuit 401 includes a reference NMOS transistor 415 whose drain is coupled to a voltage source set to a predetermined reference such as VREF, and whose gate is controlled by a reference gate signal REF. The REF signal may be related back to the PGA 134 gain in a relationship expressed as: REF=VREF/(gain+V_{T}). The source of the transistor 415 is coupled in series with another NMOS transistor 418 whose gate is controlled by the sample and hold (SHR/SHS) signal provided by the control block 120 during the signal sampling stage. The source of the transistor 418 is coupled to an output node 440 that is also coupled to the column line of a column of pixel cells 412n to 412n+1. The PIX_OUT signal is output from the column line at node 440, but the magnitude of the PIX_OUT signal is limited by the clamping circuit 401. Specifically, the reduction in voltage of the PIX_OUT signal from its reset value as the pixel is exposed is limited by the clamping circuit 401, as described in greater detail below.

In operation, the transistor 418 is turned OFF during the reset stage by a low SHR_EN signal. Consequently, the voltage Vᵣₑₛₑₜ is output as the pixel output signal PIX_OUT, and its value is not affected by the clamping circuit 401. The sampling circuit 130 of FIG. 3 then obtains a sample of the Vᵣₑₛₑₜ voltage. During the signal sampling stage, the transistor 418 is turned ON by a high SHS_EN signal. As the photodiode 430 is exposed to light, the voltage coupled to the output node 440 through the row select transistor 428 decreases from the Vᵣₑₛₑₜ level. If the PIX_OUT signal level at the output node 440 decreases substantially, it would represent an overexposure condition in which the dynamic range of the analog signal chain 105 (FIG. 3) could be exceeded. To prevent this from happening, the transistor 415 begins to turn ON when the voltage at the output node 440 falls to the level of VREF−V_{T}, where V_{T} is threshold voltage of the transistor 415. When this occurs, the transistor 415 begins to couple the supply voltage VCC to the node 440, thereby preventing any further reduction in the PIX_OUT signal level at the output node 440. In this manner, the claiming circuit 401 prevents the PIX_OUT signal level from reaching an overexposure condition in which the dynamic range of the analog signal chain 105 (FIG. 3) could be exceeded.

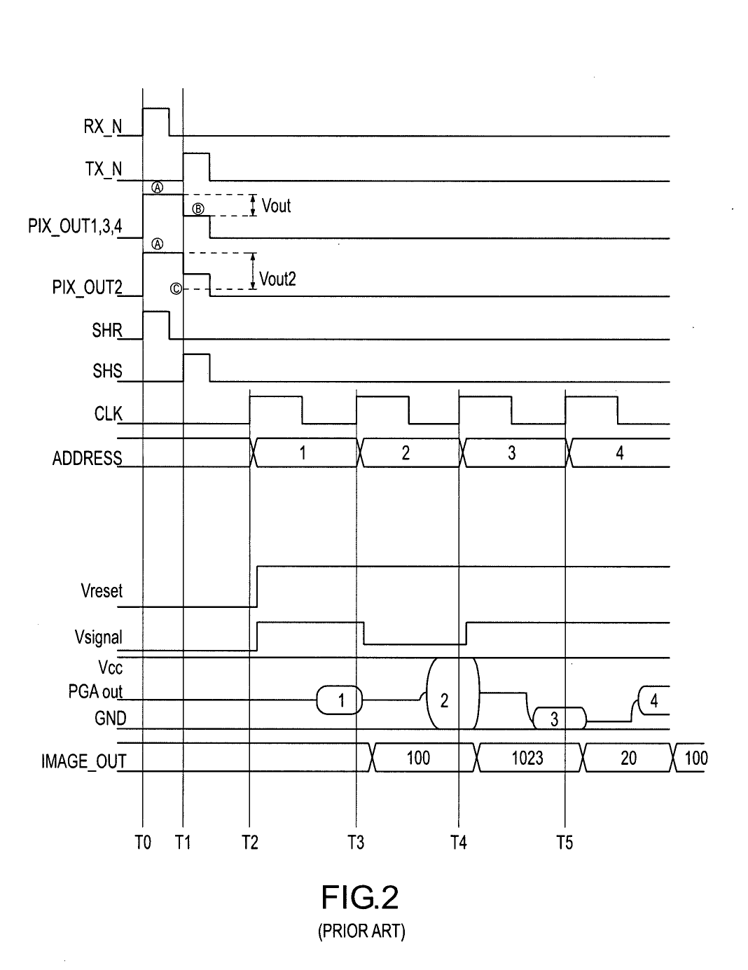

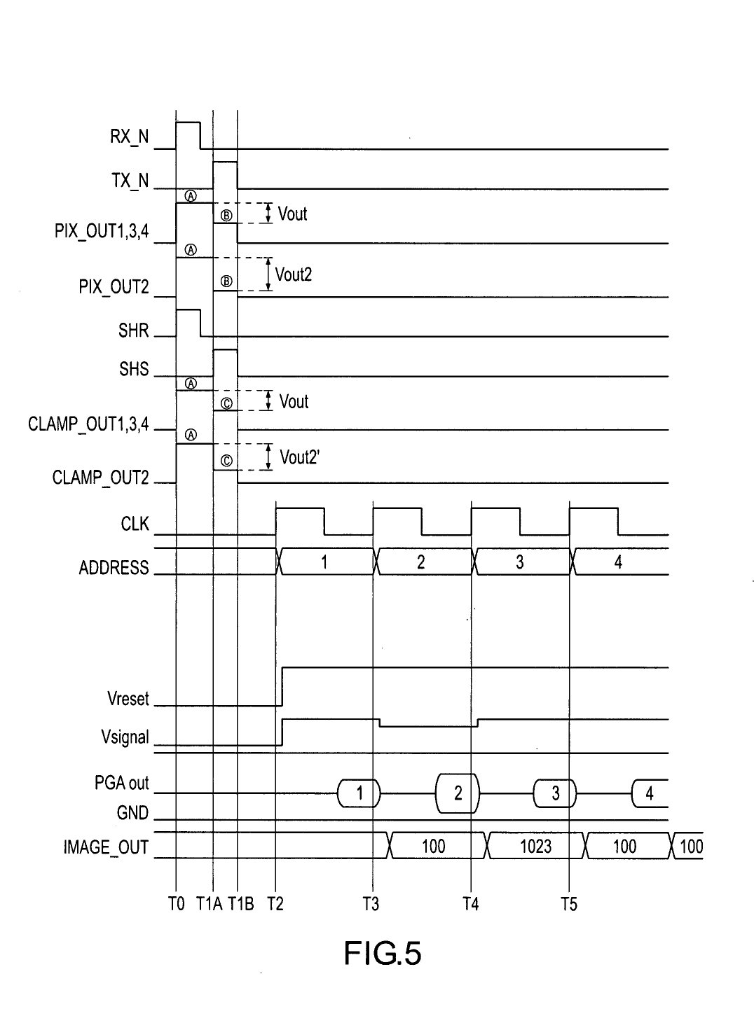

FIG. 5 is a timing diagram illustrating the operation of the CMOS imager device 300 of FIG. 3 that utilizes the clamping circuit 401 of FIG. 4. Several of the timing signals shown in FIG. 5 have been previously described with respect to FIG. 2. Therefore, in the interest of brevity, an explanation of the same timing signals will not be repeated. The timing diagram of FIG. 5 additionally shows the CLAMP_OUT signals for the four pix_out signals previously described. Between times T0 to T1A, all of the PIX_OUT signals have the signal level A applied to the output node 440 during the reset stage, as previously described. During the signal sampling stage, the PIX_OUT1,3,4 signals are again within the normal range of signal levels at level Bbetween times T1A and T1B. In these cases the PIX_OUT signal is unaffected by the clamp out circuit 401. However, the level of the PIX_OUT2 is again too small, likely due to overexposure of the pixel connect to the column line 2. In this case, the clamp out circuit 401 limits the PIX_OUT2 signal to level C. Due to the higher signal level C of the PIX_OUT signal level C, the second PGA_OUT signal is not overdriven at time T4 and the third PGA_OUT signal is shown as a normal signal time T5, and not affected by the higher second PGA_OUT signal at time T4.

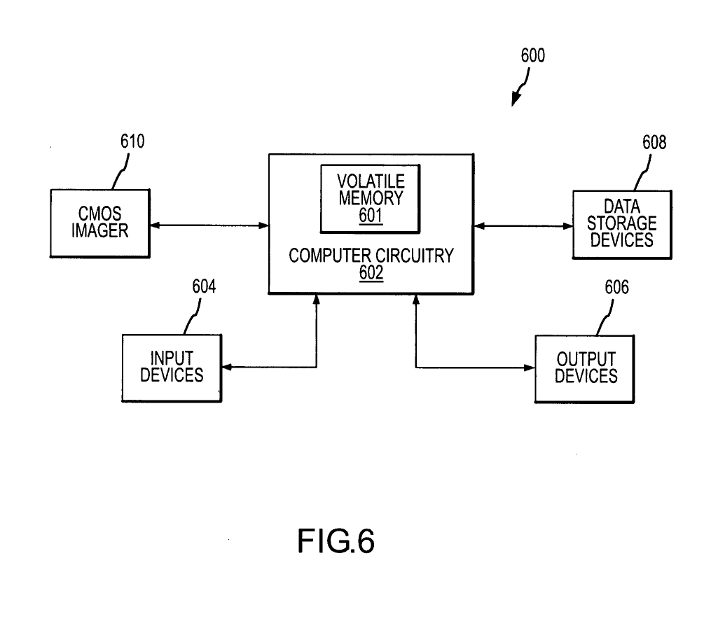

FIG. 6 is a block diagram of an embodiment of a computer system 600 that includes a CMOS imager device 610. The computer system 600 includes the CMOS imager 610 having the clamping circuit 340 of FIG. 3 in accordance with embodiments of the invention. Such a system may be included in a camera system, laptop, scanner, video system, and others systems having the CMOS imager device 610. Conventionally, the computer circuitry 602 is coupled through address, data, and control buses to a volatile memory device 601 to provide for writing data to and reading data from the volatile memory device 601. The computer circuitry 602 includes circuitry for performing various processing functions, such as executing specific software to perform specific calculations or tasks. In addition, the computer system 600 may include one or more input devices 604, such as a keyboard or a mouse, coupled to the computer circuitry 602 to allow an operator to interface with the computer system 600. Typically, the computer system 600 may also include one or more output devices 606 coupled to the computer circuitry 602, such as output devices typically including a printer and a video terminal. One or more data storage devices 608 are also typically coupled to the computer circuitry 602 to store data or retrieve data from external storage media (not shown). Examples of typical storage devices 608 include hard and floppy disks, tape cassettes, compact disk read-only (“CD-ROMs”) and compact disk read-write (“CD-RW”) memories, and digital video disks (“DVDs”). Data storage devices 608 may also include devices to store data that is to be retained even when power is not supplied to the computer system 600 or the data storage devices 608, such as a flash memory device (not shown) according to some other examples of the invention.

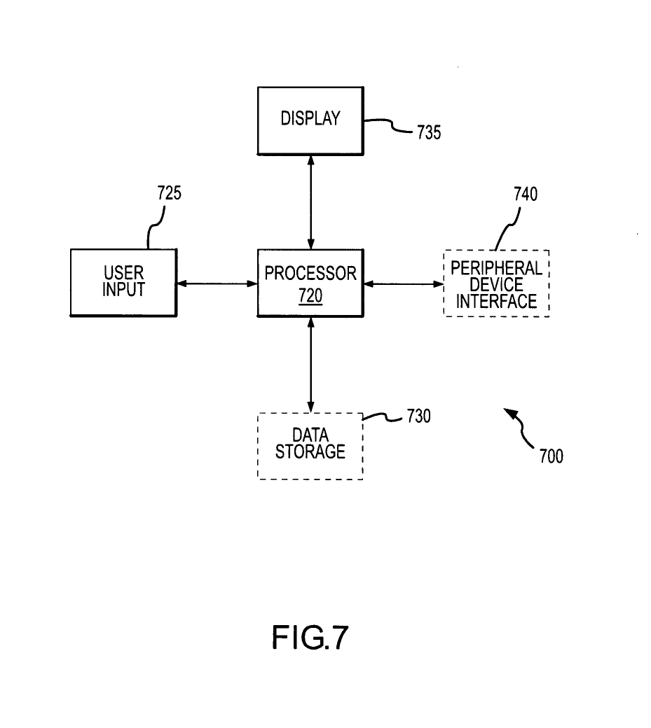

FIG. 7 is a block diagram of a consumer device 700 having a processor 720 and a user input 725 that includes the CMOS imager device 300 of FIG. 3 according to embodiments of the invention. The consumer device 700 may be a digital camera, a vehicle navigation system, videophone, cell phone, audio player with imaging capabilities, or other small devices and portable devices that utilize CMOS imaging technology. The processor 720 may be a microprocessor, digital signal processor, or part of a central processing unit that communicates with the user input 725 over a bus. The processor may 720 additionally have a random access memory (RAM) or, alternatively, the user input 725 may include the RAM to which the processor communicates over the bus. The CMOS imager device 300 may be combined with the processor 720 with or without memory storage on a single integrated circuit or on a different chip than the processor 720. The consumer device 700 includes a display 735, such as a cathode ray tube (CRT) or liquid crystal display (LCD), for displaying information captured by the imager device 300. The consumer device 700 may also include a storage device 730, such as removable Flash memory, capable of storing data processed by processor 720, including, for example, digital image data. The consumer device 700 may optionally have a peripheral device interface 740 so that the processor 720 may communicate with a peripheral device (not shown). A number of peripheral devices may be connected to the consumer device 700, such as a camera lens, an audio recorder or a microphone, or a battery pack.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A pixel read out circuit, comprising:
an output node coupled to a plurality of pixel cells, the output node configured to output a first signal from a selected one of the plurality of pixel cells; and
a clamp-out circuit coupled to the output node and to a reference node, the clamp-out circuit operable to limit the magnitude of the first signal to a predetermined level.

2. The pixel read out circuit of claim 1 wherein the predetermined level is determined by a reference signal applied to the reference node.

3. The pixel read out circuit of claim 1 wherein each of the plurality of pixel cells comprises:
a photosensing device operable to convert an optical signal to an electrical signal;
a sensing node coupled to the photosensing device and operable to receive and store an electrical charge due to the electrical signal from the photosensing device;
a reset transistor coupled to the sensing node and operable to reset the charge on the sensing node to a predetermined voltage; and
a read out circuit coupled to the sensing node, the read out circuit operable to detect the charge on the sensing node and generate an output signal on the output node.

4. The pixel read out circuit of claim 3 wherein the first signal from the selected one of the plurality of pixel cells comprises a reset signal provided when the charge on the sensing node is reset and a sample signal provided when the charge on the sensing node is charged by the photosensing device.

5. The pixel read out circuit of claim 4 further comprising an amplifier circuit coupled to the clamp-out circuit and configured to receive the reset signal and the sample signal, the amplifier circuit operable to generate a final pixel output signal by taking the difference between the reset signal and the sample signal.

6. A pixel readout circuit comprising:
a first output node coupled to a plurality of pixel cells, the first output node configured to output a first signal from a selected one of the plurality of pixel cells; and
a clamp circuit having a second output node coupled to the first output node, the clamp circuit having a transistor configured to receive a reference voltage at a gate of the transistorto render the transistor conductive responsive to the first signal level being less than a magnitude determined by the magnitude of the reference voltage.

7. The pixel read out circuit of claim 6 wherein each of the plurality of pixel cells comprises:
a photosensing device operable to convert an optical signal to an electrical signal;
a sensing node coupled to the photosensing device and operable to receive and store an electrical charge due to the electrical signal from the photosensing device;
a reset transistor coupled to the sensing node and operable to reset the charge on the sensing node to a predetermined voltage; and
a read out circuit coupled to the sensing node, the read out circuit operable to detect the charge on the sensing node and generate an output signal on the output node.

8. The pixel read out circuit of claim 7 wherein the first signal from the selected one of the plurality of pixel cells comprises a reset signal provided when the charge on the sensing node is reset and a sample signal provided when the charge on the sensing node is charged by the photosensing device.

9. The pixel read out circuit of claim 8 further comprising an amplifier circuit coupled to the clamp circuit and configured to receive the reset signal and the sample signal, the amplifier circuit operable to generate a final pixel output signal by taking the difference between the reset signal and the sample signal.

10. The pixel read out circuit of claim 9 wherein the clamp circuit further comprises a second transistor configured to receive a sample and hold sample (SHS) control signal, the second transistor operable to enable the comparison between the reference signal and the first signal when the first signal is a sample signal.

11. An imager circuit comprising:
an array of pixel cells arranged in rows and columns, each of the pixel cells coupled to a column line and operable to output a first and second pixel output signal on the respective column line;
a clamping circuit coupled to the array of pixel cells to receive the pixel output signals on the respective column line, the clamping circuit operable to receive a reference signal and to limit the voltage level of each of the pixel output signal to a voltage level determined by the magnitude of the reference signal;
a sampling circuit coupled to the clamping circuit, and configured to receive the pixel output signals from the clamping circuit, the sampling circuit operable to sample and collect each of the pixel output signals;
an amplifier circuit coupled to receive the pixel output signals from the sampling circuit, the amplifier circuit operable to generate a final output signal by taking the difference of the first pixel output signal and the second pixel output signal; and
an analog-to-digital converter operable to receive the final output signal from the sampling circuit and operable to convert the final output signal into a digital image signal.

12. The imager circuit of claim 11 wherein each of the plurality of pixel cells comprises:
a photosensing device operable to convert an optical signal to an electrical signal;
a sensing node coupled to the photosensing device and operable to receive and store an electrical charge due to the electrical signal from the photosensing device;
a reset transistor coupled to the sensing node and operable to reset the charge on the sensing node to a predetermined voltage; and
a read out circuit coupled to the sensing node, the read out circuit operable to detect the charge on the sensing node and generate an output signal on the output node.

13. The imager circuit of claim 12 wherein the first pixel output signal comprises a reset signal provided when the charge on the sensing node is reset, and the second pixel output signal comprises a sample signal provided when the charge on the sensing node is charged by the photosensing device.

14. The pixel read out circuit of claim 13 wherein the clamping circuit comprises a plurality of clamping circuit units, wherein each of the clamping circuit units comprises:
a first transistor configured to receive a first control signal, the first transistor operable to enable the comparison between the reference signal when the pixel output signal is the sample signal; and
a second transistor coupled to the first transistor and configured to receive the reference signal at a gate of the second transistor, the second transistor being rendered conductive if the magnitude of the sample signal is less than the magnitude of the reference signal offset by a threshold voltage of the second transistor.

15. A computer system comprising:
a data input device;
a data output device;
a data storage device;
a plurality of buses to and from the data input, output and storage devices;
computing circuitry coupled to the data input, output and storage devices, the computing circuitry operable to process data to and from the data input and output devices on the plurality of buses; and
an imager device coupled to the computing circuitry, the imager device comprising a pixel read out circuit further comprising:
an output node coupled to a plurality of pixel cells, the output node configured to output a first signal from a selected one of the plurality of pixel cells; and
a clamp-out circuit coupled to the output node and to a reference node configured to receive a reference signal, the clamp-out circuit operable to limit the magnitude of the first signal to a level determined by the magnitude of the reference signal.

16. The computer system of claim 15 wherein the first signal from the selected one of the plurality of pixel cells comprises a reset signal provided when the selected one of the plurality of pixel cells is reset, and a sample signal provided when the selected one of the plurality of pixel cells is charged due to accumulating a photo-generated charge.

17. The computer system of claim 16 further comprising an amplifier circuit coupled to the clamp-out circuit and configured to receive the reset signal and the sample signal, the amplifier circuit operable to generate a final pixel output signal by taking the difference between the reset signal and the sample signal.

18. The computer system of claim 17 wherein the clamp-out circuit further comprises:
a first transistor configured to receive a first control signal, the first transistor operable to enable the comparison between the reference signal when the first signal is the sample signal; and
a second transistor coupled to the first transistor and configured to receive the reference signal, the second transistor operable to enable the output of the second signal when the value of the first signal is less than the value of the reference signal.

19. The computer system of claim 15 wherein the data storage device comprises a removable Flash memory device.

20. The computer system of claim 15 wherein the computer circuitry comprises a volatile memory configured to store system software.

21. A method for reading a pixel output signal in a imager circuit comprising:
receiving a first signal from a pixel cell;
limiting the first signal to magnitude determined by a magnitude of a reference signal; and
outputting the limited first signal.

22. The method of claim 21 wherein the act of limiting the first signal to a magnitude determined by a magnitude of a reference signal comprises applying the reference signal to a gate of a transistor, applying a supply voltage to a drain of the transistor and applying the first signal to a source of the transistor, wherein the transistor conducts if the magnitude of the first signal is less than the magnitude of the reference signal by at least a threshold voltage of the transistor.

23. The method of claim 21 further comprising:
resetting a sensing node of the pixel cell;
converting an optical signal to an electrical signal; and
sampling the sensing node after resetting the sensing node and after converting the optical signal to an electrical signal.

24. The method of claim 23 further comprising calculating a final pixel output signal by taking the difference of the sampled signal after converting the optical signal from the sampled signal after resetting the sensing node.

25. A method of generating a digital image in an imager device comprising:
outputting at least one pixel signal on a column line of a plurality of column lines coupling an array of pixel cells arranged in rows and columns;
clamping the magnitude of the at least one pixel signal to a voltage determined by the voltage of a reference signal;
sampling the at least one pixel signal and sampling at least another pixel signal;
generating a final pixel output signal by taking the signal difference of the at least one pixel signal from the at least another pixel signal; and
converting the final pixel output signal to a digital image signal.

26. The method of claim 25 wherein the act of limiting the magnitude of at least one pixel signal to a voltage determined by the voltage of a reference signal comprises applying the reference signal to a gate of a first transistor, applying a supply voltage to a drain of the transistor and applying the at least one pixel signal to a source of the first transistor, wherein the transistor conducts if the magnitude of the first signal is less than the magnitude of the reference signal.

27. The method of claim 26 wherein the act of outputting the at least one pixel signal comprising:
resetting a sensing node of the pixel cell;
converting an optical signal to an electrical signal; and
sampling the sensing node after resetting the sensing node to generate the at other pixel signal and after converting the optical signal to an electrical signal to generate the at least one pixel signal.

28. The method of claim 27 wherein the act of comparing the at least one pixel signal to the reference signal further comprises enabling a second transistor to couple the first transistor to the at least one pixel signal only in a signal sample stage, wherein the sensing node is sampled after converting the optical signal to the electrical signal.
